(19) United States
(12) Patent Application Publication
(10) Pub. No.: US 2006/0056471 A1
(43) Pub. Date: Mar. 16, 2006

(54) Laser drive circuit

(75) Inventor: Sueo Ueno, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/938,721

(22) Filed: Sep. 13, 2004

(51) Int. Cl. H01S 3/00

(52) U.S. Cl. 372/38.02

(57) ABSTRACT

When a switch SW1 is turned on by an HSYNC signal, a comparison circuit compares an output of a photodiode LD with a reference signal. The comparison result is stored in a capacitor C1. A main scan correction signal, which is supplied from a printer CPU, is formed to decrease a light amount at a central part in a main scan direction on a photoconductor drum 5 and to increase a light amount at both sides in the main scan direction. After the main scan correction signal is added to the voltage in the capacitor C1, a gain necessary for an APC control is provided by a gain circuit. The gain is converted to a laser drive current I1 by a transistor Tr1. The laser drive current I1 is chopped and modulated with a data signal by a transistor Tr2. Thus, the photodiode LD emits light with a high laser output at both sides in the main scan direction on the photoconductor drum and with a low laser output at the central part.

### BACKGROUND OF THE INVENTION

1. Field of the Invention

The present invention relates to a laser drive circuit that controls driving of a semiconductor laser for use in a digital multi-function peripheral, a laser printer, etc.

2. Description of the Related Art

In a conventional multi-function peripheral, if the number of print sheets and the resolution are increased, the number of revolutions of a polygon motor increases. As a result, the life of the motor decreases and noise increases. In addition, a longer time is needed to reach a target value of the number of revolutions, and the time for first printing increases.

There is known an “over-fill” scheme as a method of overcoming this problem. According to this scheme, the number of facets of the polygon mirror is increased. Thereby, the number of scans per revolution of the motor is increased. In this case, a laser spot formed on the mirror is enlarged and a laser beam is radiated on a plurality of facets of the mirror so that the laser beam may be radiated over a range of movement of the mirror for a single scan on the drum. As a result, the amount of light decreases on both sides in the main scan direction of a radiation spot, that is, on the front side and rear size on the drum.

### BRIEF SUMMARY OF THE INVENTION

The object of an aspect of the present invention is to provide a laser drive circuit capable of correcting a decrease in light amount on a front side and a rear side in a main scan direction in an over-fill scheme.

According to an aspect of the present invention, there is provided a laser drive circuit that drives a semiconductor laser which is used at a time of scanning a photoconductor body using an over-fill type polygon mirror, comprising: temperature correction means for correcting a light emission amount, relative to a temperature variation in the semiconductor laser; addition means for adding a correction signal for correcting a light emission amount in a main scan direction of the photoconductor body to a correction result obtained by the temperature correction means; and modulation means for modulating, with a data signal, a signal obtained by the addition of the correction signal by the addition means.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of an aspect of the invention.

FIG. 1 is a block diagram that schematically shows the structure of a digital multi-function peripheral according to the present invention;

FIG. 2 is a view for explaining an under-fill optical system;

FIG. 3 is a view for explaining an over-fill optical system;

FIG. 4 is a view for explaining the principle of scanning of the under-fill optical system;

FIG. 5 is a view for explaining the principle of scanning of the over-fill optical system;

FIG. 6 is a view illustrating a laser intensity distribution on an over-fill type polygon mirror;

FIG. 7 shows an intensity distribution on both sides on a photoconductor drum;

FIG. 8 is a circuit diagram showing the structure of a laser drive circuit 1 according to a first embodiment;

FIG. 9 is a time chart illustrating a correction operation in the first embodiment;

FIG. 10 is a circuit diagram showing the structure of a laser drive circuit 2 according to a second embodiment;

FIG. 11 is a time chart illustrating a correction operation in the second embodiment;

FIG. 12 is a circuit diagram showing the structure of a laser drive circuit 3 according to a third embodiment;

FIG. 13 is a time chart illustrating a correction operation in the third embodiment;

FIG. 14 is a circuit diagram showing the structure of a laser drive circuit 4 according to a fourth embodiment; and

FIG. 15 is a time chart illustrating a correction operation in the fourth embodiment.

### DETAILED DESCRIPTION OF THE INVENTION

Embodiments of the present invention will now be described with reference to the accompanying drawings.

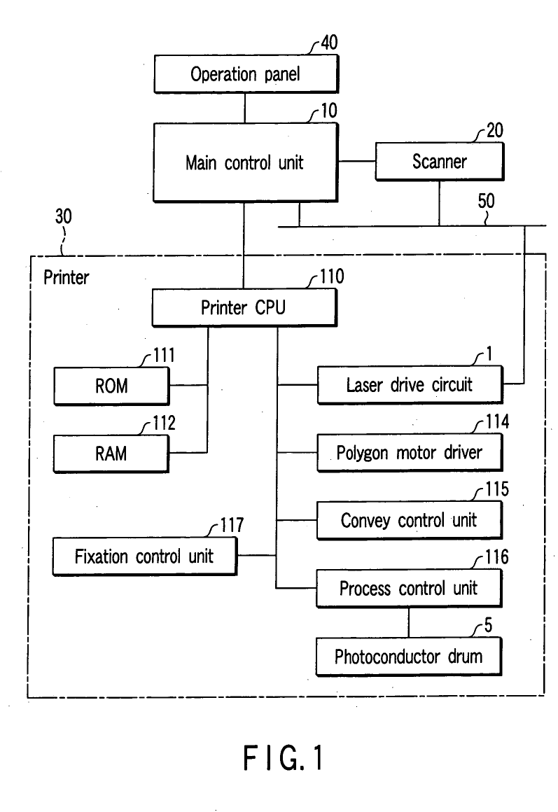

FIG. 1 schematically shows the structure of a digital multi-function peripheral (MFP) according to the image forming apparatus of the present invention. The digital multi-function peripheral comprises a main control unit 10 that executes an overall control, a scanner 20 that scans an image on an original, a printer 30 that effects print-out, and an operation panel 40 that executes an operation input. An image data bus 50 interconnects an image processing unit (not shown) provided in the main control unit 10, the scanner 20 and the printer 30, and executes transmission/reception of image data.

The printer 30 comprises a printer CPU 110 that executes an overall control; a ROM 111 that stores a control program, etc.; a RAM 112 for storing data; a laser drive circuit 1 that drives a laser diode (to be described later); a polygon motor driver 114 that drives a polygon motor (not shown); a convey control unit 115 that controls conveyance of paper by a convey mechanism (not shown); a process control unit 116 that controls a process for executing charging, development and transfer by using a photoconductor drum 5; and a fixation control unit 117 that controls a fixing device (not shown).

As will be described later in detail, a first embodiment of the present invention employs a laser drive circuit 1, a second embodiment of the invention employs a laser drive circuit 2, a third embodiment of the invention employs a laser drive circuit 3, and a fourth embodiment of the invention employs a laser drive circuit 4.

To begin with, a description is given of the schematic structure of a laser optical system in an image forming apparatus that executes laser exposure, such as a laser printer or a digital multi-function peripheral.

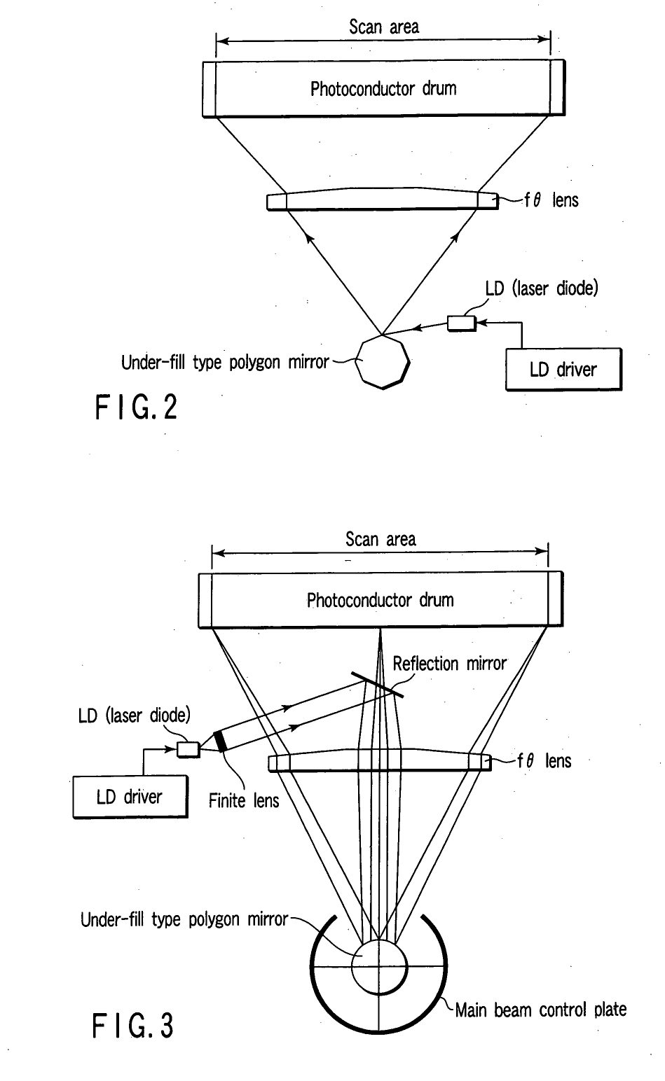

FIG. 2 to FIG. 7 are views for describing the background of the invention. Thus, reference numerals are omitted.

FIG. 2 illustrates an under-fill optical system. The number of facets of a polygon mirror is small, and an incidence pupil of a laser beam on the mirror facet is a point-incidence pupil both in a rotational direction and a rotation-axis direction, relative to the mirror facet. Basically, a single scan is completed with a single incidence pupil on a single mirror facet.

FIG. 3 illustrates an over-fill optical system. The number of facets of a polygon mirror is large. Since each mirror facet is small, a single scan cannot be completed with a single mirror facet. Thus, the incidence pupil is widened in the polygon-rotation direction so that a laser beam is simultaneously radiated on a necessary number of mirror facets for completion of a single scan.

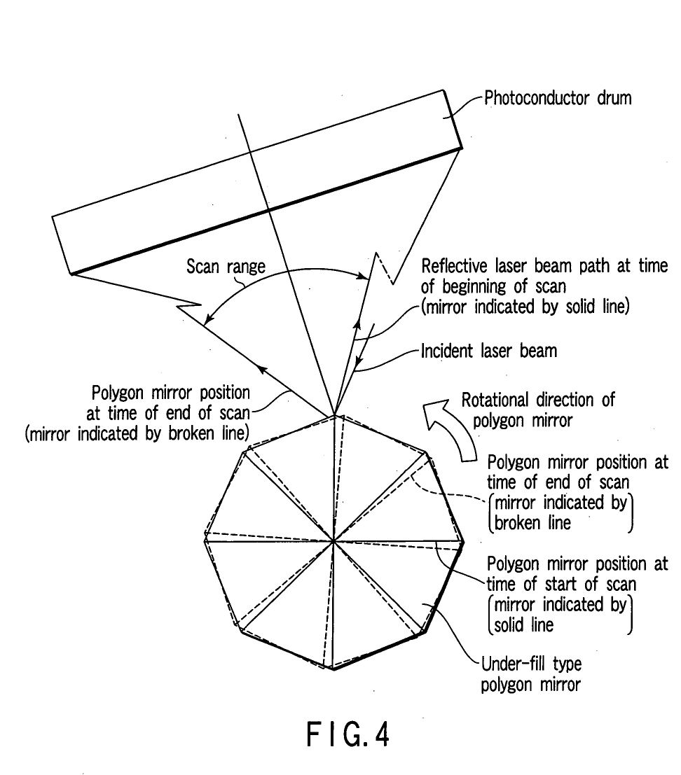

FIG. 4 illustrates details of the principle of scanning of the under-fill optical system. In FIG. 4, an incident laser beam is stationary at one point, and the polygon mirror is at a scan start position (the mirror indicated by a solid line). A reflective beam travels along a laser beam reflection path at the time of scan start. If the polygon mirror rotates in the rotational direction thereof, the beam scans a scan range in accordance with an angular variation of the mirror facet during the rotation. At the polygon mirror position (mirror indicated by a broken line) at the time of the end of scan, the scanning is effected up to a position of the laser beam reflection path at the time of the end of scan. The scan range is set so as to fall within the area of effective printing of the photoconductor drum.

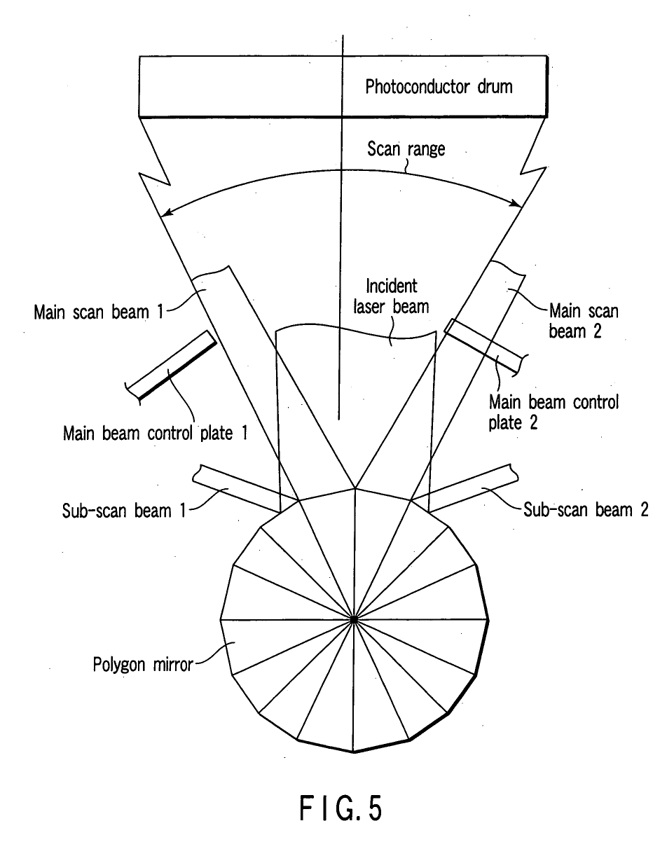

FIG. 5 illustrates the principle of scanning of the over-fill optical system. FIG. 5 indicates beam positions at the time of scan start and scan end.

In FIG. 5, an incident laser beam is shaped so as to illuminate, e.g. three mirror facets of the polygon mirror at a time. Depending on the angle of the mirror, the beam illuminates four facets at a time, and reflective light from the four facets is produced. Thus, the reflective beam is restricted by main beam control plates 1 and 2 so that the scan area on the photoconductor drum can be scanned by a single reflective main beam alone.

In FIG. 5, if the polygon mirror rotates in the polygon-rotation direction thereof, a scan main beam 1 is located near the terminal end of the scan range. If the polygon mirror further rotates, the beam is blocked by the main beam control plate 1 and falls out of the scan range. In turn, a scan main beam 2, which has been blocked by a main beam control plate 2, emerges into the scan range, and the next scan begins.

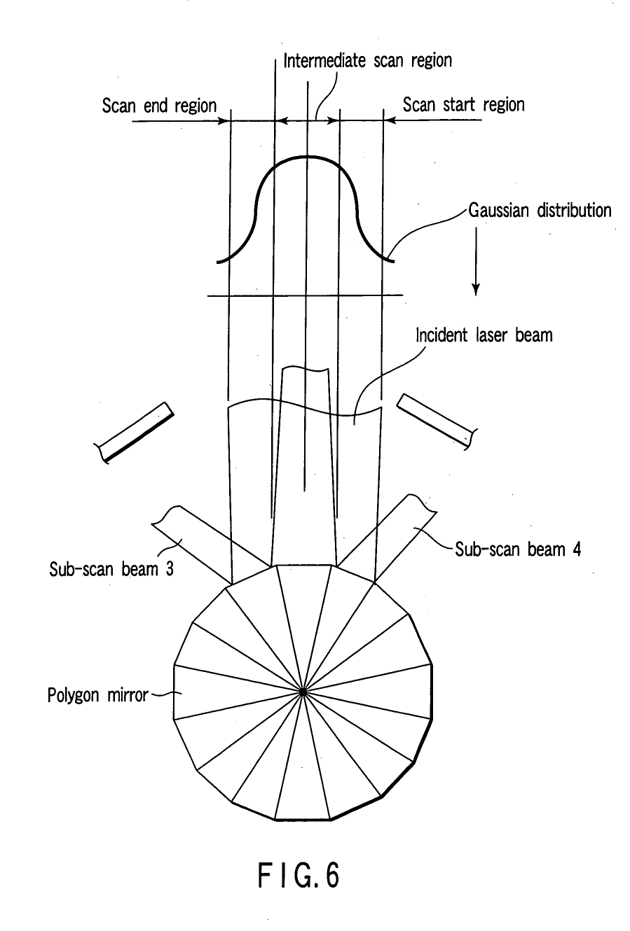

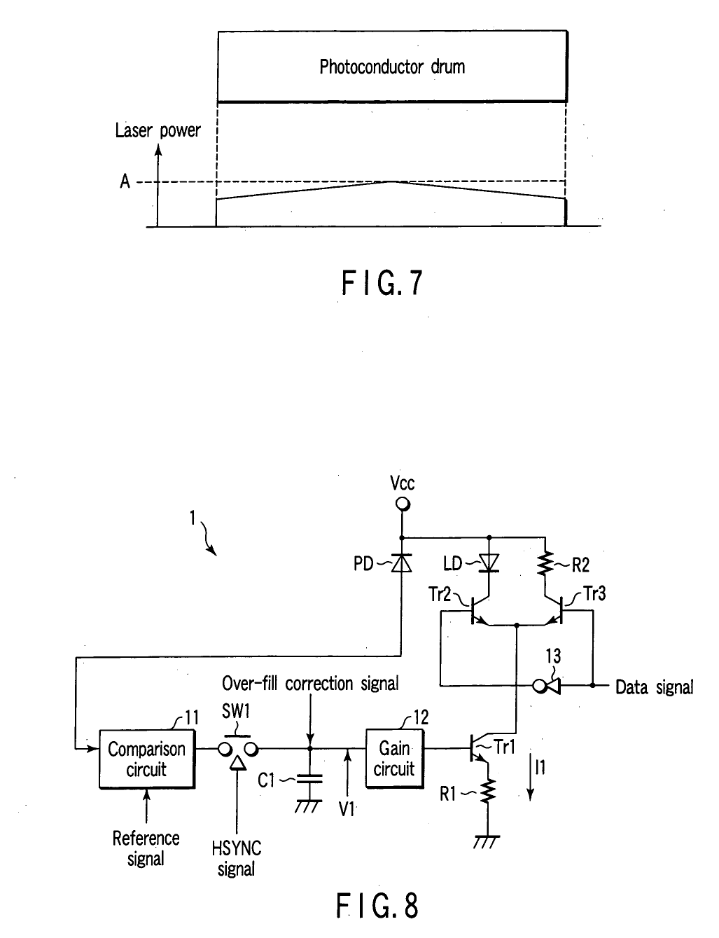

FIG. 6 illustrates a laser intensity distribution on an over-fill type polygon mirror. The laser intensity distribution constitutes a Gaussian distribution, and three facets of the mirror are illuminated. The laser intensity is lower at the scan start region and scan end region than at the intermediate scan region. Consequently, as shown in FIG. 7, the intensity distribution decreases at both sides of the photoconductor drum.

In the present invention, the laser light amount is corrected so that the intensity distribution may not decrease at both sides.

Next, a first embodiment of the invention is described.

FIG. 8 shows the structure of a laser drive circuit 1 in the first embodiment. The laser drive circuit 1 comprises a laser diode (semiconductor laser) LD, a photodiode PD, transistors Tr1, Tr2 and Tr3, a comparison circuit 11, a gain circuit 12, a NOT gate 13, a switch SW1, a capacitor C1, and resistors R1 and R2.

A data signal is supplied via the image data bus 50.

A reference signal, an HSYNC signal (horizontal sync signal) and an over-fill correction signal are supplied from the printer CPU 110 that serves as supply means.

The laser drive circuit 1 generally comprises an APC circuit (temperature correction means) that corrects a temperature variation in the laser diode LD, and a modulation circuit (modulation means) that executes optical modulation with record data. The APC circuit detects the light mission amount of the laser diode LD by the photodiode PD, and compares it with the reference signal. Thereby, the APC circuit executes a negative feedback so as to increase or decrease the drive current for the laser diode LD and to control the light emission amount at a target value. The negative feedback is effected only while the switch SW1 is closed. The comparison result is retained in the capacitor C1 as C1 voltage. In accordance with this value, the current flowing to the laser diode LD is determined. The correction in the first embodiment is executed for voltage V1 of the capacitor C1.

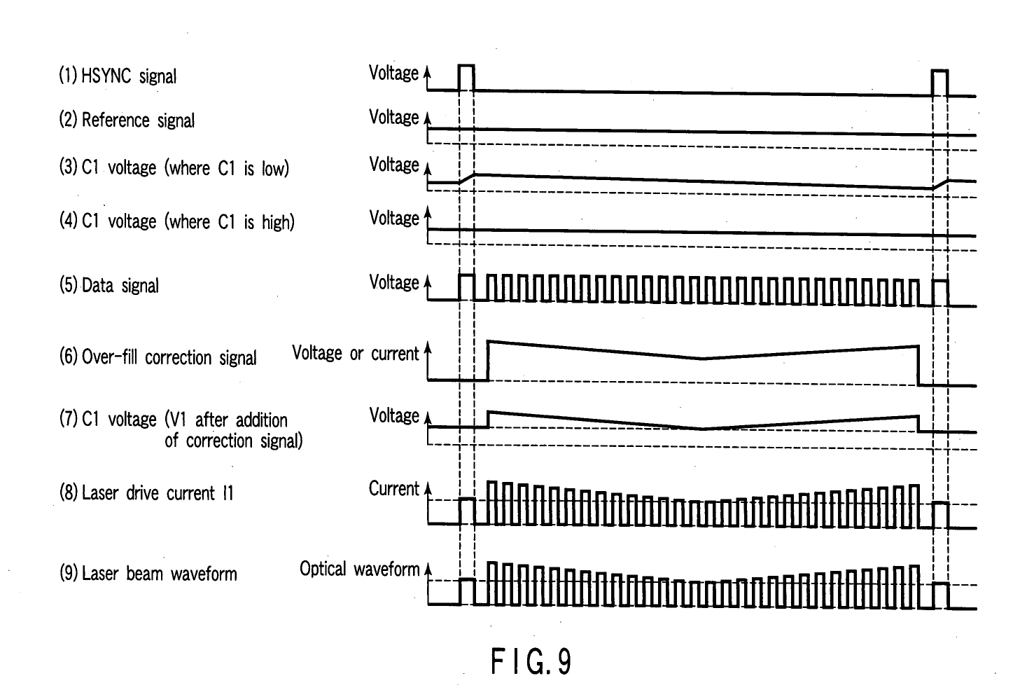

FIG. 9 is a time chart illustrating the correction operation in the first embodiment.

In FIG. 9, the switch SW1 is turned on only during the time period of HSYNC signal (cycle between the rising edge and the falling edge) indicated by (1), and the APC circuit is connected.

When the switch SW1 is turned on by the HSYNC signal, the comparison circuit 11 compares the output of the photodiode LD with the reference signal indicated by (2). The comparison result is stored in the capacitor C1. If the capacitance is small, as indicated by (3), discharge progresses within the cycle of the HSYNC signal and the light amount decreases. Thus, the capacitance is increased up to a value that matches with the HSYNC cycle, so that no discharge occurs in one cycle of the HSYNC signal, as indicated by (4).

Assume that a data signal as indicated by (5) is input.

A main scan correction signal indicated by (6) decreases the light amount at a central part in the main scan direction on the photoconductor drum 5 since the light amount falls at both sides in the main scan direction on the photoconductor drum 5. In other words, the over-fill correction signal corrects the light amount in accordance with a deviation in light amount in the main scan direction in the case of using the over-fill type polygon mirror.

Since the negative feedback is executed only in the period of the HSYNC signal, the voltage of the capacitor C1 has a voltage waveform as indicated by (7), after the addition of the main scan correction signal (addition means). The C1 voltage is provided with a gain necessary for the APC control by the gain circuit 12. The transistor Tr1 converts the output voltage of the gain circuit 12 to a laser drive current I1. The laser drive current I1 is chopped and modulated by the transistor Tr2 with the data signal 20.

As a result, the laser drive current I1 varies as indicated by (8).

The laser diode LD emits light with a laser light waveform as indicated by (9). In other words, the laser diode LD emits light such that the laser output is high at both sides in the main scan direction on the photoconductor drum 5 and is low at the central part.

Next, a second embodiment is described.

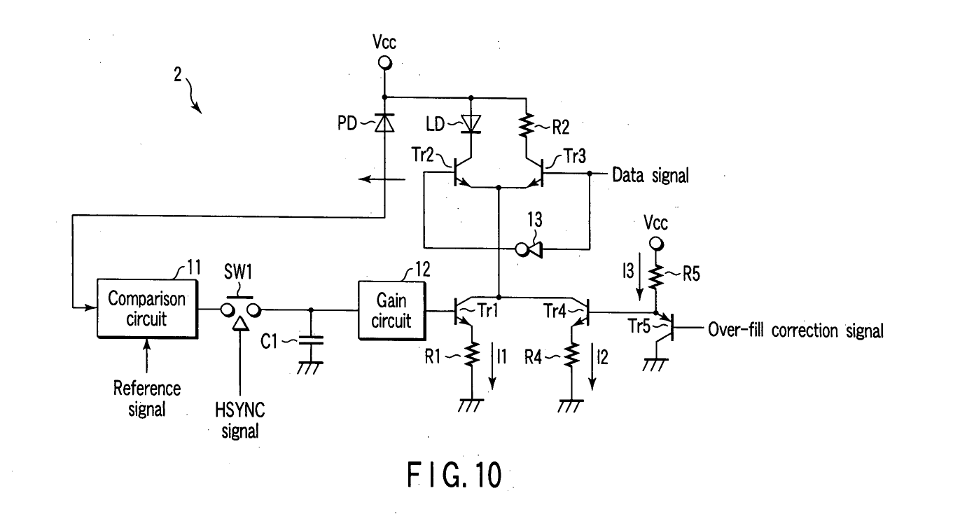

FIG. 10 shows the structure of a laser drive circuit 2 in the second embodiment. The laser drive circuit 2 comprises a laser diode LD, a photodiode PD, transistors Tr1, Tr2, Tr3, Tr4 and Tr5, a comparison circuit 11, a gain circuit 12, a NOT gate 13, a switch SW1, a capacitor C1, and resistors R1, R2, R4 and R5.

A data signal is supplied via the image data bus 50.

A reference signal, an HSYNC signal and an over-fill correction signal are supplied from the printer CPU 110 that serves as supply means.

The laser drive circuit 1 generally comprises an APC circuit that corrects a temperature variation in the laser diode LD, and a modulation circuit that executes optical modulation with record data. The APC circuit detects the light mission amount of the laser diode LD by the photodiode PD, and compares it with the reference signal. Thereby, the APC circuit executes a negative feedback so as to increase or decrease the drive current for the laser diode LD and to control the light emission amount at a target value. The negative feedback is effected only while the switch SW1 is closed. The comparison result is retained in the capacitor C1 as C1 voltage. A gain necessary for the APC operation is provided by the gain circuit 12. The transistor Tr1 converts the output of the gain circuit 12 to a laser drive current I1, thereby driving the laser diode LD.

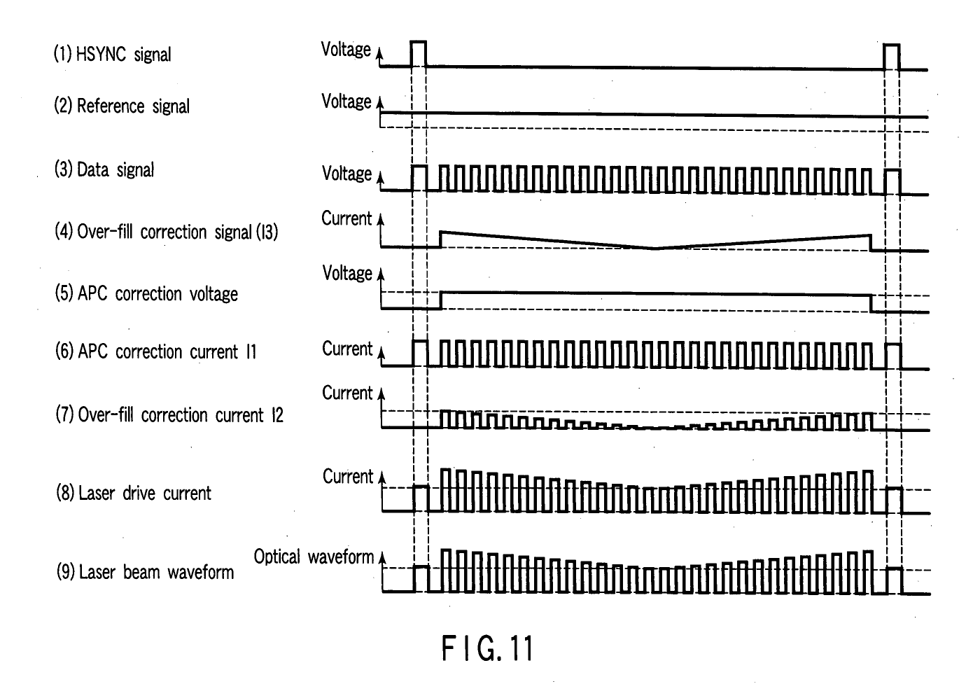

FIG. 11 is a time chart illustrating the correction operation in the second embodiment.

In FIG. 11, the switch SW1 is turned on only during the time period of HSYNC signal (cycle between the rising edge and the falling edge) indicated by (1), and the APC circuit is connected.

The reference signal indicated by (2) in FIG. 11 and the data signal indicated by (3) are the same as those in the first embodiment.

The over-fill correction signal indicated by (4) is converted to a current I3 by the transistor Tr5, and the current I3 is further converted to an over-fill correction current I2 indicated by (7) by the transistor Tr4.

The transistors Tr4 and Tr5 are complementarily connected to execute temperature compensation for the correction operation that is not included in the APC operations. The laser diode LD is supplied with a laser drive current indicated by (8), which is obtained by adding the over-fill correction current I2 indicated by (7) to the APC correction current I1 indicated by (6). Further, the laser drive current is modulated into a data signal by the transistors Tr2 and Tr3.

As a result, the laser diode LD emits light with a laser light waveform as indicated by (9). In other words, the laser diode LD emits light such that the laser output is high at both sides in the main scan direction on the photoconductor drum 5 and is low at the central part.

As described above, the over-fill correction signal corrects the light amount in accordance with the deviation in light amount in the main scan direction in the case of using the over-fill type polygon mirror.

Next, a third embodiment is described.

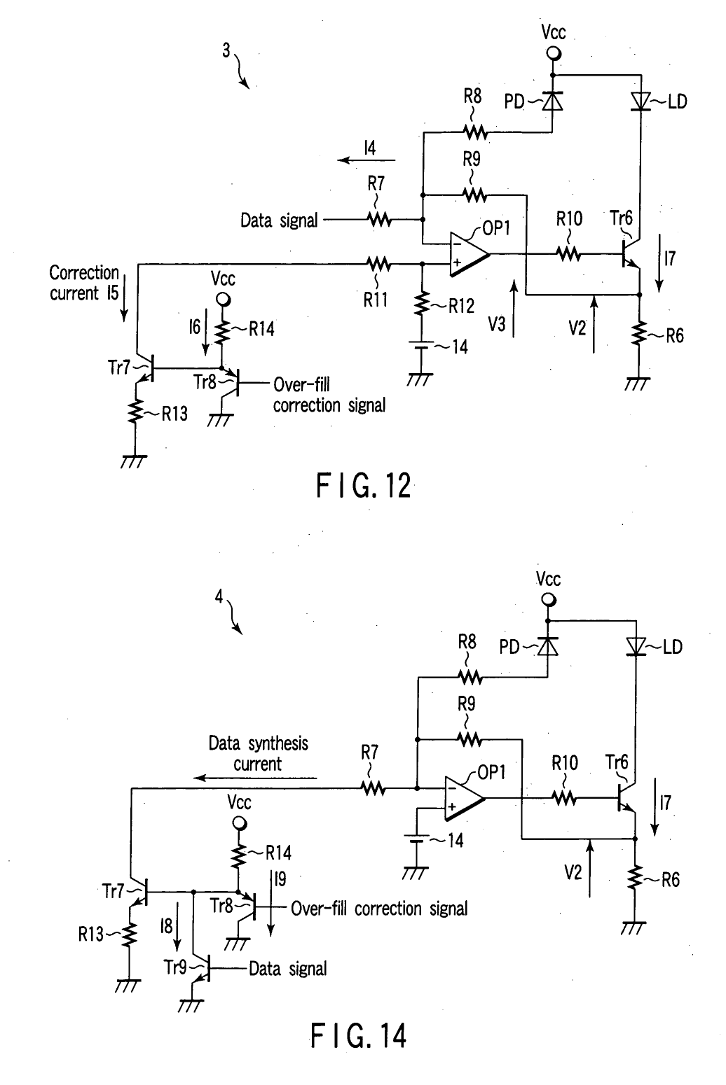

FIG. 12 shows the structure of a laser drive circuit 3 in the third embodiment. The laser drive circuit 3 comprises a laser diode LD, a photodiode PD, transistors Tr6, Tr7 and Tr8, an operational amplifier OP1, a reference value supply section 14, and resistors R6, R7, R8, R9, R10, R11, R12, R13 and R14.

The reference value supply section 14 is supplied with a reference signal from the printer CPU 110.

The data signal is supplied via the image data bus 50.

The over-fill correction signal is supplied from the printer CPU 110.

The operational amplifier OP1 operates like an ordinary well-known operational amplifier, and controls an output so as to make a (−) input agree with a (+) input.

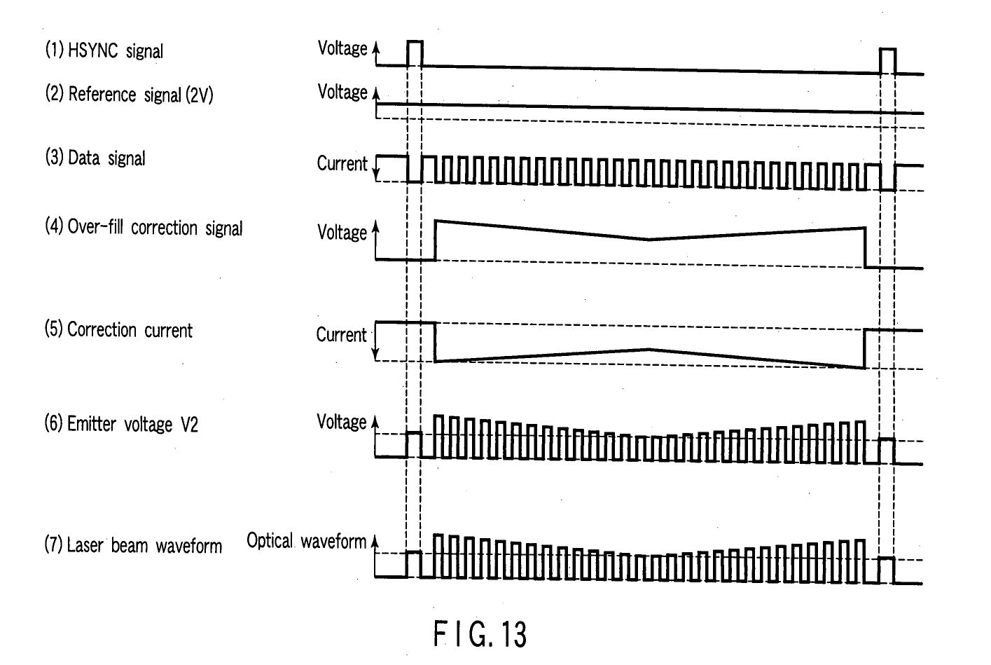

FIG. 13 is a time chart illustrating the correction operation in the third embodiment.

Assume that the reference value (reference signal (2)) of the reference value supply section 14 is at a fixed DC level, e.g. 2V. In the case where the voltage drop of the resistor R7 due to the current I4 of the data signal corresponds to a division by an addition voltage of a voltage, which is obtained by dividing voltage V2 at a ratio between the resistors R7 and R8, and an output voltage of the photodiode PD, the operational amplifier OP1 controls the voltage V2 so that the (−) input may become 2V (reference value).

If the voltage V3 is 0V, and the current I4 is 0A, the (+) input and (−) input are both 0V. Thus, the output of the operational amplifier OP1 is controlled so that the voltage V2 may become 0V.

If the voltage of the reference signal is 2V, the operational amplifier OP1 controls the voltage V2 so that the (−) input may become 2V. In this case, if the data current (data signal (3)) that is obtained by modulating the current I4 with data is supplied, a balance in voltage drop between the resistors R7, R9 and R8 is lost. To avoid this, the operational amplifier OP1 controls the voltage V2 with a voltage that is obtained by dividing the addition voltage of the output voltage of the photodiode PD through the resistor R8 and the feedback voltage V2 through the resistor R9. In short, the laser drive current of current I7 is modulated with the data signal and, as a result, the laser beam waveform is modulated with data.

If the correction current I5 (correction current (5)) is superimposed on the reference signal, the operational amplifier OP1 controls the (−) input so as to provide a voltage variation corresponding to a variation in the correction current I5. If the modulation of the data signal is added, the operational amplifier OP1 that serves as control means executes a control so as to vary the voltage V2 (emitter voltage V2 (6)) such that the data signal is superimposed on the variation of the correction current I5.

As a result, the laser diode LD emits light with a waveform (laser beam waveform (7)) in which the over-fill correction signal and the data signal are superimposed.

Next, a fourth embodiment is described.

FIG. 14 shows the structure of a laser drive circuit 4 in the fourth embodiment. The laser drive circuit 4 comprises a laser diode LD, a photodiode PD, transistors Tr6, Tr7, Tr8 and Tr9, an operational amplifier OP1, a reference value supply section 14, and resistors R6, R7, R8, R9, R10, R13 and R14.

The reference value supply section 14 is supplied with a reference signal from the printer CPU 110.

The data signal is supplied via the image data bus 50.

The over-fill correction signal is supplied from the printer CPU 110.

The laser drive circuit 4 of the fourth embodiment is configured such that the data signal in the laser drive circuit 3 of the third embodiment is supplied between the transistors Tr7 and Tr8 via the transistor Tr9. The basic operation of the circuit is the same as in the third embodiment, so a description is omitted. Only different parts are described.

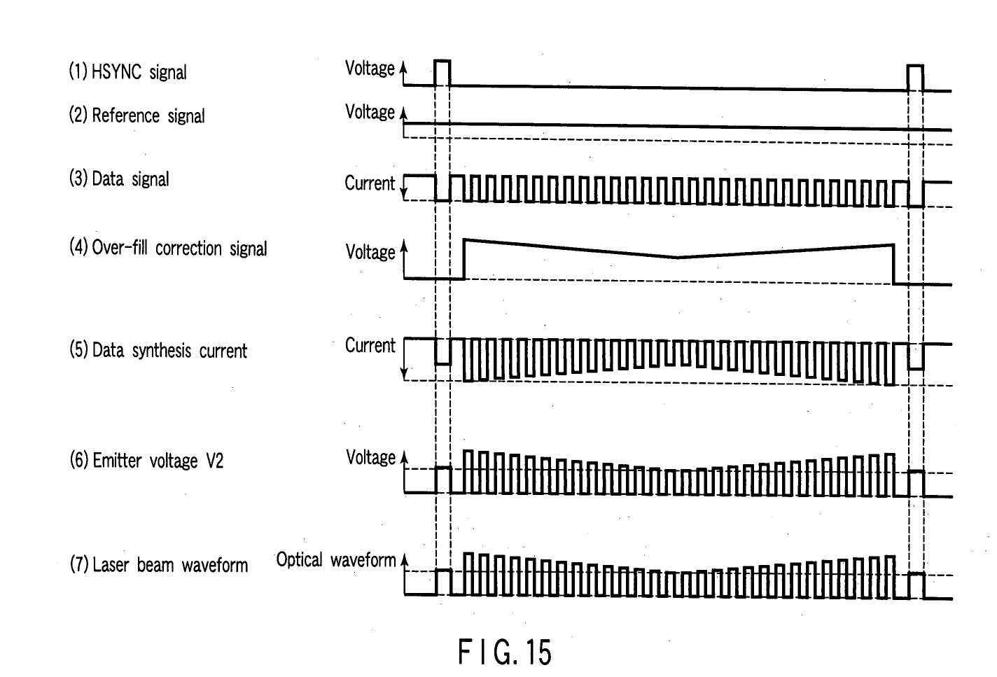

FIG. 15 is a time chart illustrating the correction operation in the fourth embodiment.

Assume that the reference value (reference signal (2)) of the reference value supply section 14 is at a fixed DC level, e.g. 2V. Like the third embodiment, the data signal is a data signal (current) indicated by (3).

If the over-fill correction signal indicated by (4) is superimposed on the data signal, the current I8 of the data signal and the current I9 of the over-fill correction signal are synthesized (data synthesis current (5)) and input to the (−) input terminal of the operational amplifier OP1. The operational amplifier OP1 that serves as control means executes a control so as to make the variation of the data synthesis current agree with a voltage variation (emitter voltage V2 (6)) corresponding to the reference voltage (reference signal (2)).

As a result, the laser diode LD emits light with a waveform (laser beam waveform (7)) in which the over-fill correction signal and the data signal are superimposed.

As has been described above, the embodiments of the present invention can eliminate a difference in laser intensity distribution between both side part and a central part in the scan range of the over-fill optical system, and can provide a high quality image.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A laser drive circuit that drives a semiconductor laser which is used at a time of scanning a photoconductor body using an over-fill type polygon mirror, comprising:
temperature correction means for correcting a light emission amount, relative to a temperature variation in the semiconductor laser;
addition means for adding a correction signal for correcting a light emission amount in a main scan direction of the photoconductor body to a correction result obtained by the temperature correction means; and
modulation means for modulating, with a data signal, a signal obtained by the addition of the correction signal by the addition means.

2. The laser drive circuit according to claim 1, wherein the temperature correction means corrects the light emission amount of the semiconductor laser at a target value by comparison with a preset reference signal.

3. The laser drive circuit according to claim 1, wherein the temperature correction means operates only in a scan period for scanning the photoconductor body.

4. The laser drive circuit according to claim 1, wherein the temperature correction means operates in accordance with a cycle of a horizontal sync signal at a time of scanning the photoconductor body.

5. The laser drive circuit according to claim 1, wherein the addition means adds the correction signal for correcting the light emission amount in the main scan direction of the photoconductor body to a capacitor that stores a correction result obtained by the temperature correction means.

6. The laser drive circuit according to claim 1, wherein the correction signal added by the addition means corrects the light emission amount of the semiconductor laser in accordance with a cycle of a horizontal sync signal at a time of scanning the photoconductor body.

7. The laser drive circuit according to claim 1, wherein the correction signal added by the addition means corrects the light emission amount of the semiconductor laser in accordance with a deviation in light amount in the main scan direction on the photoconductor body.

8. A laser drive circuit that drives a semi-conductor laser which is used at a time of scanning a photoconductor body using an over-fill type polygon mirror, comprising:
temperature correction means for correcting a light emission amount, relative to a temperature variation in the semiconductor laser; and
modulation means for modulating a correction result obtained by the temperature correction means with a correction signal for correcting a light emission amount in a main scan direction of the photoconductor body and with a data signal that is supplied.

9. The laser drive circuit according to claim 8, wherein the correction signal corrects the light emission amount of the semiconductor laser in accordance with a deviation in light amount in the main scan direction on the photoconductor body.

10. A laser drive circuit that drives a semi-conductor laser which is used at a time of scanning a photoconductor body using an over-fill type polygon mirror, comprising:
temperature correction means for correcting a light emission amount of the semiconductor laser, relative to a temperature variation in the semiconductor laser, on the basis of comparison with a preset reference signal;
superimposition means for superimposing a correction signal for correcting a light emission amount in a main scan direction of the photoconductor body upon the reference signal that is used by the temperature correction means; and
control means for executing a control to superimpose a data signal on a variation in the reference signal on which the correction signal is superimposed by the superimposition means.

11. The laser drive circuit according to claim 10, wherein the correction signal corrects the light emission amount of the semiconductor laser in accordance with a deviation in light amount in the main scan direction on the photoconductor body.

12. A laser drive circuit that drives a semi-conductor laser which is used at a time of scanning a photoconductor body using an over-fill type polygon mirror, comprising:
superimposition means for superimposing a correction signal for correcting a light emission amount in a main scan direction of the photoconductor body upon a data signal; and
control means for executing a control to make a variation of a synthesis signal between the data signal and the correction signal, which are superimposed by the superimposition means, agree with a voltage variation corresponding to a preset reference signal.

13. The laser drive circuit according to claim 12, wherein the correction signal corrects the light emission amount of the semiconductor laser in accordance with a deviation in light amount in the main scan direction on the photoconductor body.
